(19) United States
(12) Patent Application Publication
(10) Pub. No.: US 2023/0324497 A1
(43) Pub. Date: Oct. 12, 2023

(54) DEVICES AND METHODS FOR 3D POSITION DETERMINATION

(71) Applicant: Toposens GmbH, Muchen (DE)

(72) Inventors: Alexander RUDOY, München (DE); Rinaldo Giovanni PERSICHINI, München (DE); Victor TOMASHEVICH, München (DE); Christian WELK, München (DE); Michele CORONA, München (DE)

(21) Appl. No.: 17/767,855

(22) PCT Filed: Oct. 9, 2020
(86) PCT No.: PCT/EP2020/078441

§ 371 Date: Apr. 8, 2022

(30) Foreign Application Priority Data
Oct. 10, 2019 (EP) 19202377.8

(51) Int. Cl. G01S 3/808; G01S 5/22; G01S 5/20; G01S 7/53

(52) U.S. Cl. CPC G01S 3/8083; G01S 5/22; G01S 5/20; G01S 7/53

(57) ABSTRACT

A receiving unit is disclosed, including at least three receivers, each configured to receive an ultrasonic signal with a wavelength λ from the transmitting unit. A first receiver is arranged at a distance of at most one half wavelength λ/2 of the ultrasonic signal from a second receiver and from a third receiver. The at least three receivers are arranged in one plane. A processor is configured to determine the respective time-of-flight from the ultrasonic signal received at each of the at least three receivers. The respective time-of-flight is a time that the ultrasonic signal requires from the transmitting unit at a defined start time to the respective receiver. The processor is further configured to determine the three-dimensional position and/or direction of the transmitting unit from the determined times-of-flight and the arrangement of the at least three receivers.

### CROSS-REFERENCE TO RELATED APPLICATIONS

The present application is a U.S. national stage entry of International Application No. PCT/EP2020/078441, filed Oct. 9, 2020, which claims priority to European Patent Application No. 19202377.8, filed Oct. 10, 2019, the entire disclosures of which are incorporated herein by reference.

### FIELD

The present invention relates to devices and methods for 3D position determination and/or determination of a direction of a transmitting unit.

### BACKGROUND

Various techniques are known from the background of the art which can determine the position of a transmitter.

EP 0 215 940 B1 relates to a location determination of a plurality of targets, wherein temporal pulses reflected from the targets are detected by at least three sensors.

US 2007/0197229 A1 relates to a system for determining the relative position of a target, object, or location to a wireless communication device.

US 2011/0111751 A1 relates to a system for identifying, tracking and locating objects in a wireless network.

WO 2010/085877 A1 relates to a system for position determination of one or more transmitters using one or more receivers.

US 2018/0143292 A1 relates to a method for determining a three-dimensional position using ultrasonic signals.

However, the aforementioned publications have deficiencies regarding the accuracy of position determination or are based on complicated methods.

For example, in some of the known methods, individual time-of-flight measurements are performed one after the other. Thus, these methods achieve a relatively low measuring frequency.

### SUMMARY

The present invention is based on the object of providing methods and devices that allow for a position determination of a transmitter in three-dimensional space with a high degree of precision and with little effort.

This object is achieved by the features of the independent patent claims. The dependent claims relate to further aspects of the invention.

According to one aspect of the present invention, a receiving unit for determining the three-dimensional position and/or direction of a transmitting unit is provided. The receiving unit comprises: at least three, preferably only three, receivers, each configured to receive an ultrasonic signal with a wavelength λ from the transmitting unit, wherein a first receiver is arranged at a distance of at most one half wavelength λ/2 of the ultrasonic signal from a second receiver and from a third receiver, wherein the first receiver and the second receiver are arranged on a first straight line and the first receiver and the third receiver are arranged on a second straight line, wherein the first straight line and the second straight line form an angle of 80° to 100°, preferably of 85° to 95°, particularly preferably of essentially 90° and in particular of 90° to one another, and wherein the at least three receivers are preferably arranged in one plane; and a processor that is configured to determine the respective time-of-flight from the ultrasonic signal received at each of the at least three receivers, wherein the respective time-of-flight is a time that the ultrasonic signal requires from the transmitting unit at a defined start time to the respective receiver, and wherein the processor is further configured to determine the three-dimensional position and/or direction of the transmitting unit from the determined times-of-flight and the arrangement of the at least three receivers.

By determining the different times-of-flight from a single ultrasonic signal, the measuring frequency can be increased compared to systems in which each time-of-flight measurement is performed one after the other. In other words, according to the present invention, the time-of-flight measurements are performed “simultaneously”, wherein the various time-of-flight measurements are separated only by their specific differences in time-of-flight (difference between the time that the signal needs to reach a first receiver and a second receiver).

If the aforementioned arrangement of the receivers, described as optional, is used, the accuracy of the method of the present invention is highest at an angle of 90° between the first and second straight lines. However, this optional arrangement is not limited to the exact value of 90°, but at the expense of accuracy, deviations from the 90° angle (right angle) can also lead to usable results, as expressed by the ranges around 90° mentioned above.

However, the present invention is not limited to the aforementioned arrangement of the receivers, described as optional. Rather, the receivers can be freely arranged in the plane. In the case of a predefined arrangement, e.g. a right-angled arrangement, the calculation algorithm becomes simpler and therefore less computing power is required. Furthermore, the results are more accurate since, e.g., the amount of rounding errors decreases due to the lower complexity of the calculation.

Due to tolerances in the manufacturing process, it is possible that the receivers are placed offset from the target position. This error can be corrected by calibration (determination of the actual position of the microphones) and the calculation algorithm for the free arrangement.

Due to the free arrangement of the receivers, different designs can be implemented, which means more flexibility in the design of the receiving unit.

The processor is preferably designed as an integral part of the receiving unit.

Alternatively, the processor can be designed as an independent component and be connected to the receiving unit via a cable or wirelessly.

Preferably, the at least three receivers each comprise a microphone.

The receiving unit preferably also has at least one amplifying unit configured to amplify the received ultrasonic signals and/or at least one filtering unit configured to filter the received ultrasonic signals.

The amplifying unit and/or the filtering unit can improve the signal quality of the received ultrasonic signals by amplifying the received ultrasonic signals or by filtering out interference signals. Thus, the signal-to-noise ratio of the actual measurement signals to any interference signals can be improved, which may lead to an improvement in the accuracy of the position determination.

Preferably, the receiving unit is further configured to transmit a synchronization signal prior to receiving the ultrasonic signal to initiate transmission of the ultrasonic signal by the transmitting unit and to define the start time for determining the respective time-of-flight.

Preferably, the receiving unit has a radio module that is configured to transmit the synchronization signal.

Preferably, the processor is also configured to start a timer for each of the at least three receivers upon transmission of the synchronization signal to determine the respective times-of-flight.

If the signal is received by one of the receivers, the time-of-flight can be determined by the respective timer. In other words, the respective time-of-flight corresponds to the time of the corresponding timer at the time the respective signal was received.

By transmitting the synchronization signal as described above, a defined start time for the respective time-of-flight can be determined.

The processor can further be configured to determine the time of reception of the ultrasonic signal at the first receiver by intersection in order to determine the time-of-flight, wherein the intersection comprises polynomial interpolation through respective inflection points of the positive and negative sides of a transient process of the amplitude of the received ultrasonic signal, wherein preferably only the inflection points which are above a certain first limit value of the positive amplitude and wherein only the inflection points which are below a certain second limit value of the negative amplitude are used, wherein the first limit value is preferably equal to the second limit value.

The transient process of the received ultrasonic signal can be defined as the magnitude of the amplitude of the received ultrasonic signal increasing over time, wherein the inflection points on the positive side of the amplitude are the respective maxima of the positive amplitude in the transient process and the inflection points on the negative side of the amplitude are the respective minima of the negative amplitude in the transient process.

According to another aspect of the present invention, the direction of the transmitter can be determined. Determining the direction of the transmitter does not require a synchronization signal, as described above, since the difference in times-of-flight is relative and does not depend on a defined start time of the time-of-flight measurement. The differences in time-of-flight of the received signals are determined as described. The difference in times-of-flight clearly indicates the azimuth or elevation angle relative to the plane of the receiver. In this way, the direction of the transmitter can be determined.

Preferably, the processor is further configured to determine the respective time-of-flight based on the phase shift between the received ultrasonic signals.

Preferably, the processor is further configured to determine the three-dimensional position of the transmitting unit based on intersecting circular paths.

Preferably, the processor is further configured to determine the radius of the circular paths based on the respective time-of-flight.

Preferably, the determination of the phase shift between the received ultrasonic signals comprises: determining the phase shift between the respective inflection points of the positive and negative sides of a transient process of the amplitude of the ultrasonic signal received at the first receiver and the ultrasonic signal received at the second receiver, and between the respective inflection points of the positive and negative sides of a transient process of the amplitude of the ultrasonic signal received at the first receiver and the ultrasonic signal received at the third receiver, and the formation of a respective average value of the phase shift, and wherein the respective average values are preferably added, in each case, to the time of reception of the ultrasonic signal at the first receiver to determine the respective time-of-flight of the ultrasonic signal to the second and third receivers.

The processor can further be configured to determine a signal quality of the received ultrasonic signals, wherein determination of the signal quality preferably comprises: determining the first times t_{fn} between successive inflection points of the received ultrasonic signals from a first inflection point to an n-th inflection point; determining the second times tₚₙ between the first inflection point and third through n-th inflection points; and determining the signal quality by comparing the times t_{fn} and tₚₙ with a respective predetermined target value t_{fn_target} and t_{pn_target}.

The processor can further be configured to determine whether or not the determined times t_{fn} and tₚₙ are within a predetermined tolerance range and to use the associated inflection point for averaging if the determined times t_{fn} and tₚₙ are within a predetermined tolerance range or to discard the inflection point, if the determined times t_{fn} and tₚₙ are within a predetermined tolerance range.

The tolerance range can be a predefined tolerance range.

Preferably, the ultrasonic signal is in the range from 20 kHz to 1 GHz, more preferably in the range from 20 kHz to 500 kHz and particularly preferably in the range from 30 kHz to 80 kHz.

The receiving unit described above is not limited to receiving ultrasonic signals. The receiving unit can also comprise at least one transmitting unit. Thus, the receiving unit can have both the receiving functionality described above and a transmitting functionality of the transmitting unit described above. In other words, the receiving unit can additionally have the functionality of the transmitting unit described above.

This configuration can be advantageous, for example, in a system with two receiving units, in which case at least one of the two receiving units can also have the functions of the transmitting unit.

If two receiving units with additional transmitting units are used, one of the receiving units can be configured to receive the signals and the second receiving unit can be configured to transmit the signals, as required. This configuration can be changed as required, such that in a first configuration the first receiving unit transmits the signals and the second receiving unit receives the signals, and in a second configuration the first receiving unit receives the signals and the second receiving unit transmits the signals.

The provision of at least one receiving unit with a transmitting unit allows the receiving unit(s) to be used flexibly and leads to additional redundancies in the corresponding system.

According to a further aspect of the present invention, a connector to connect to a socket, in particular in the automotive sector, is provided. The connector has a receiving unit as described above to connect the connector to the socket.

According to a further aspect of the present invention, a socket to connect to a connector, in particular in the automotive sector, is provided. The socket has a receiving unit as described above to connect the socket to the connector.

If a connector is provided with a receiving unit, it should be understood that the corresponding socket has a transmitting unit as described above. Similarly, when the receiving unit is provided on the socket, it should be understood that the connector has a corresponding transmitting unit as described above.

According to a further aspect of the present invention, a use of the receiving unit as described above in a connector or socket to connect the connector to the socket, in particular in the automotive sector, is provided.

The connector and socket can be connected automatically by the position determination of the present invention. For this purpose, the position of the connector or the socket is determined as described above, and the connector and socket are aligned with one another based on the position determination.

The alignment of the connector to the socket or the socket to the connector is preferably checked by repeated position determination.

The accuracy of the position determination for aligning the socket and the connector can preferably be adjusted depending on the distance between the socket and the connector.

For example, it can be advantageous to roughly determine the position of the socket or the connector when there is a large distance between the connector and the socket, and to carry out the position determination more precisely when the distance between the connector and the socket is smaller. Thus, the required computing effort can be reduced. What is described here with reference to the connector or the socket applies equally to the receiving and transmitting units described above and also to the systems and methods of the present invention described below.

According to a further aspect of the present invention, a system to determine the three-dimensional position of a transmitting unit is provided. The system comprises: a transmitting unit with at least one transmitter configured to transmit an ultrasonic signal with a wavelength λ; and a receiving unit as described above.

The transmitting unit is preferably configured to receive a synchronization signal from the receiving unit.

The transmitting unit preferably has a radio module, which is configured to receive the synchronization signal from the receiving unit.

The transmitting unit is preferably also configured to transmit the ultrasonic signal after receiving the synchronization signal.

According to a further aspect of the present invention, a connector-socket system to connect a connector to a socket, in particular in the automotive sector, is provided. The connector-socket system has a system as described above. The receiving unit is provided on the connector or the socket and the transmitting unit is provided vice versa on the socket or the connector.

According to a further aspect of the present invention, a use of the system as described above is provided in a connector-socket system to connect a connector to a socket, particularly in the automotive sector.

According to a further aspect of the present invention, a method to determine the three-dimensional position and/or direction of a transmitting unit is provided. The method comprises the following steps: receiving an ultrasonic signal with a wavelength λ from the transmitting unit at at least three, preferably only three, receivers of a receiving unit, wherein a first receiver is arranged at a distance of at most one half wavelength of the ultrasonic signal 212 from a second receiver and from a third receiver, wherein the first receiver and the second receiver are arranged on a first straight line and the first receiver and the third receiver are arranged on a second straight line, wherein the first straight line and the second straight line form an angle of 80° to 100°, preferably of 85° to 95°, particularly preferably of essentially 90° and in particular of 90° to one another, and wherein the at least three receivers are preferably arranged in one plane; determining the respective time-of-flight from the ultrasonic signals received at each of the at least three receivers, wherein the respective time-of-flight is a time taken for the ultrasonic signal to travel from the transmitting unit to the respective receiver at a defined start time; and determining the three-dimensional position and/or direction of the transmitting unit from the determined times-of-flight as well as the arrangement of the at least three receivers.

The method preferably further comprises a step of amplifying the received ultrasonic signals and/or a step for filtering the received ultrasonic signals.

The method preferably further comprises a step of transmitting a synchronization signal from the receiving unit before receiving the ultrasonic signal, in order to initiate the transmission of the ultrasonic pulse by the transmitting unit and to define the starting time.

The method preferably comprises a step of starting a timer for each of the at least three receivers to determine the respective time-of-flight after transmission of the synchronization signal.

The determination of the respective time-of-flight can comprise a determination of the time of reception of the ultrasonic signal at the first receiver by intersection, wherein the intersection comprises polynomial interpolation through respective inflection points of the positive and negative sides of a transient process of the amplitude of the received ultrasonic signal, wherein preferably only the inflection points which are above a certain first limit value of the positive amplitude and wherein only the inflection points which are below a certain second limit value of the negative amplitude are used, wherein the first limit value is preferably equal to the second limit value.

The transient process of the received ultrasonic signal can be defined as the magnitude of the amplitude of the received ultrasonic signal increasing over time, wherein the inflection points on the positive side of the amplitude are the respective maxima of the positive amplitude in the transient process and the inflection points on the negative side of the amplitude are the respective minima of the negative amplitude in the transient process.

Preferably, the determination of the three-dimensional position of the transmitting unit is performed based on the phase shift between the received ultrasonic signals.

Preferably, the determination of the three-dimensional position of the transmitting unit is performed based on intersecting circular paths.

Preferably, the radius of the circular paths is determined based on the respective time-of-flight.

Preferably, the method further comprises a step of transmitting an ultrasonic signal from a transmitter provided in the transmitting unit.

Preferably, the method further comprises a step of receiving the synchronization signal from the receiving unit at the transmitting unit.

Preferably, after the step of receiving the synchronization signal, the method further comprises a step of transmitting the ultrasonic signal by the transmitting unit.

Preferably, the determination of the phase shift between the received ultrasonic signals comprises: determining the phase shift between the respective inflection points of the positive and negative sides of a transient process of the amplitude of the ultrasonic signal received at the first receiver and the ultrasonic signal received at the second receiver, and between the respective inflection points of the positive and negative sides of a transient process of the amplitude of the ultrasonic signal received at the first receiver and the ultrasonic signal received at the third receiver, and the formation of a respective average value of the phase shift, and wherein the respective average values are preferably added, in each case, to the time of reception of the ultrasonic signal at the first receiver to determine the respective time-of-flight of the ultrasonic signal to the second and third receivers.

The method can also comprise a determination of the signal quality of the received ultrasonic signals, wherein determining the signal quality preferably comprises: determining the first times t_{fn} between successive inflection points of the received ultrasonic signals from a first inflection point to an n-th inflection point; determining the second times tₚₙ between the first inflection point and third through n-th inflection points; and determining the signal quality by comparing the times t_{fn} and tₚₙ with a respective predetermined target value t_{fn_target} and t_{pn_target}.

The method can further comprise a determination whether or not the determined times t_{fn} and tₚₙ are within a predetermined tolerance range and to use the associated inflection point for averaging if the determined times t_{fn} and tₚₙ are within a predetermined tolerance range or to discard the inflection point, if the determined times t_{fn} and tₚₙ are within a predetermined tolerance range.

The tolerance range can be a predefined tolerance range.

According to a further aspect of the present invention, a computer program product is provided, comprising instructions which, when the program is executed by a computer, cause the latter to execute the method described above.

As described above, the present invention is particularly advantageous in the automotive sector.

The present invention is particularly advantageous for position determination in electric vehicles, in which a connector is to be automatically inserted into a socket mounted on a vehicle in order to charge the battery/batteries of the vehicle. For this purpose, the receiving unit described above can be provided on the connector or the socket.

If the receiving unit is provided on the connector, the transmitting unit is provided on the socket and vice versa.

In other words, the present invention is aimed in particular at sensor systems for automatic or manual docking of connector-socket systems in battery charging systems or tank systems.

Further areas of application of the present invention are sensor systems for determining the position of robots, persons or goods, e.g. in a warehouse.

The present invention can also be used in gesture control and hand tracking systems, e.g. by attaching the transmitting unit to a user's wrist.

The present invention provides a particularly precise position determination of the transmitting unit, which is required in particular in the technical fields described above.

Preferred features of the present invention comprise in particular:
at least three microphones spaced one half wavelength apart or less
the sound source to be tracked (transmitting unit) transmits sound pulses (possibly after receiving the synchronization signal)
sound pulse in the ultrasonic range (approx. 30 kHz to 80 kHz)
determination of the “x,y,z”-coordinates of the sound source triggered by the synchronization signal
triggering (as described above) is performed via a synchronization signal, e.g. a radio signal (or flash of light or time synchronization [timer])
determination of the three times-of-flight (three microphones) of the sound pulse in the time domain (no FFT) from the recorded sound signal (ADC data)
Algorithmics: two intersecting circular paths and vector calculation

A very precise determination of the times-of-flight and thus a very precise determination of the 3D positions of the transmitting unit can thus be provided by the present invention.

Features described with respect to the method according to the invention can certainly also correspond to corresponding features of the corresponding devices of the device according to the invention. Correspondingly, features of the described device of the present invention can correspond to method features.

### BRIEF DESCRIPTION OF THE DRAWINGS

The present invention is explained in more detail by means of exemplary embodiments and the figures below. In the figures:

FIG. 1 shows a schematic representation of the receiving unit according to an embodiment of the invention,

FIG. 2 shows a flowchart with steps that the receiving unit performs according to an embodiment of the invention,

FIG. 3 shows a schematic representation of the transmitting unit according to an embodiment of the invention,

FIG. 4 shows a flowchart with steps that the transmitting unit performs according to an embodiment of the invention,

FIG. 5 shows a schematic representation of the arrangement of the three receivers of the receiving unit according to an embodiment of the invention,

FIG. 6 shows a schematic representation for determining the x-coordinate of the transmitting unit according to the embodiment according to FIG. 5 of the invention,

FIG. 7 shows a schematic representation for determining the y-coordinate of the transmitting unit according to the embodiment according to FIG. 5 of the invention,

FIG. 8 shows a schematic representation for determining the z-coordinate of the transmitting unit according to the embodiment according to FIG. 5 of the invention,

FIG. 9 shows a schematic representation of the arrangement of the three receivers of the transmitting unit according to a further embodiment of the invention,

FIG. 10 shows a schematic representation of the propagation of the signal from the transmitting unit to the receiving unit according to an embodiment of the invention,

FIG. 11a shows an energy-time diagram of the received signals at the three receivers of the receiving unit according to an embodiment of the invention,

FIGS. 11b-11g show schematic representations of the signal processing at the three receivers of the receiving unit according to an embodiment of the invention,

FIG. 12 shows a schematic representation for determining the x-coordinate of the transmitting unit according to the embodiment according to FIG. 9 of the invention,

FIG. 13 shows a schematic representation for determining the y-coordinate of the transmitting unit according to the embodiment according to FIG. 9 of the invention, and

FIG. 14 shows a schematic representation for determining the z-coordinate of the transmitting unit according to the embodiment according to FIG. 9 of the invention.

### DETAILED DESCRIPTION

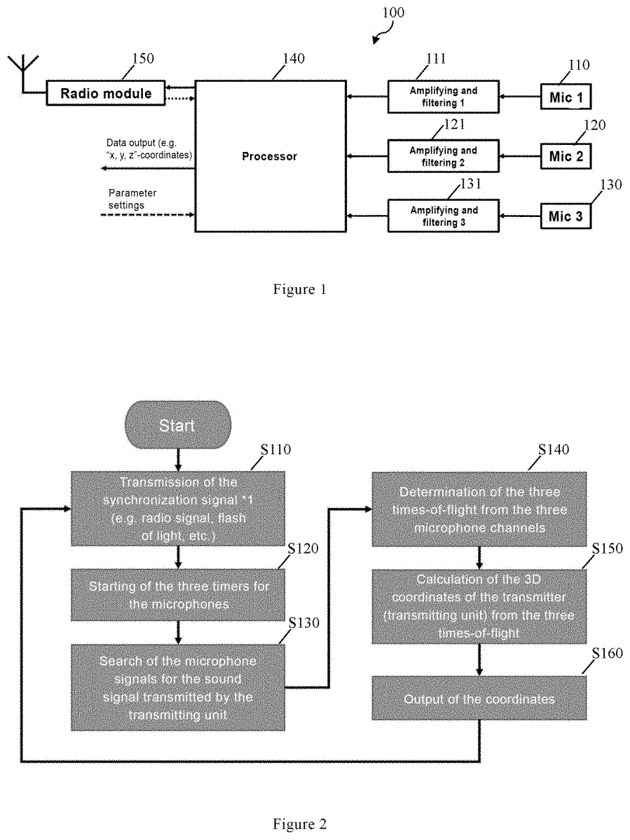

FIG. 1 shows the schematic structure of a receiving unit 100 of the present invention with a first receiver 110 (also referred to as “Mic 1”), a second receiver 120 (also referred to as “Mic 2”) and a third receiver 130 (also referred to as “Mic 3”).

The receivers 110, 120, 130 can be designed, for example, as microphones or sensors for receiving ultrasonic signals.

The receiving unit 100 also has an amplifying and filtering unit 111, 121, 131, which are each connected to one of the receivers 110, 12, 130. The amplifying and filtering units 111, 121, 131 are configured to receive the signals received at the respective receiver 110, 120, 130 and to amplify or filter them.

The amplifying and filtering units 111, 121, 131 are configured in particular to improve the signal-to-noise ratio by amplifying or filtering out the actual measurement signal from any interference signals.

Although the amplifying and filtering units 111, 121, 131 are shown as one unit each in FIG. 1, the amplifying and filtering units 111, 121, 131 can also be formed as separate units.

The receiving unit 100 also has a processor 140 which is connected to the amplifying and filtering units 111, 121, 131 and which is configured to receive and process the signals from the respective amplifying and filtering units 111, 121, 131.

The processor 140 can receive and process further data, such as parameter settings of the receiving unit 100.

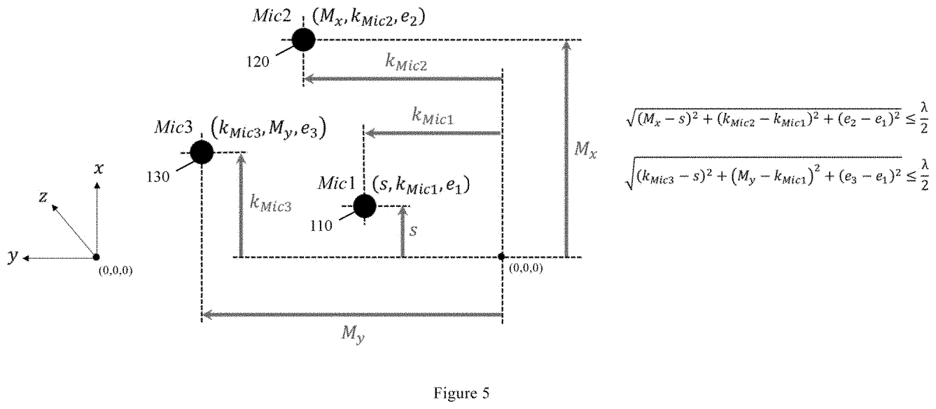

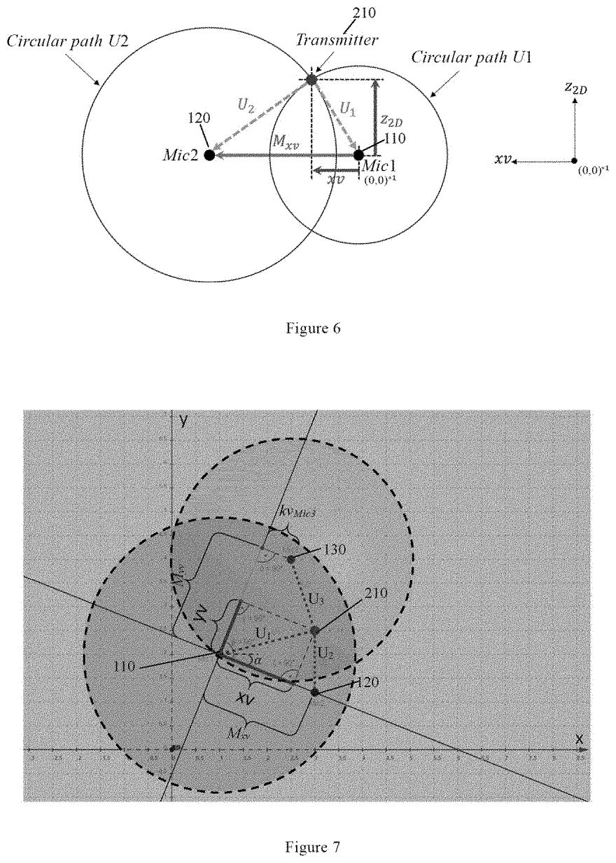

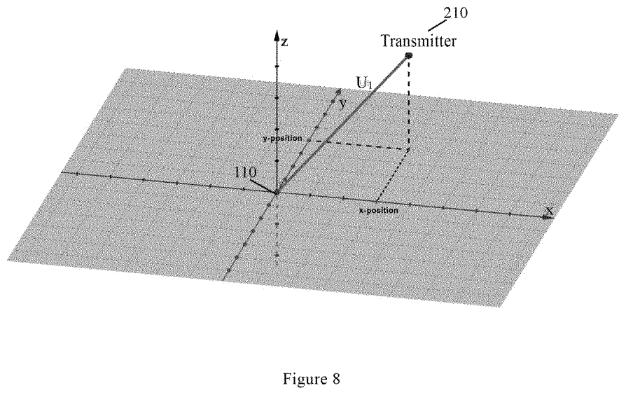

The processor 140 is configured in particular to determine the position of the transmitting unit (described in more detail below with reference to FIGS. 3 and 4) and preferably to output the corresponding “x, y, z”-coordinates of the transmitting unit. The implementation of the position determination of the transmitting unit is described in more detail below with reference to FIGS. 5 to 10.

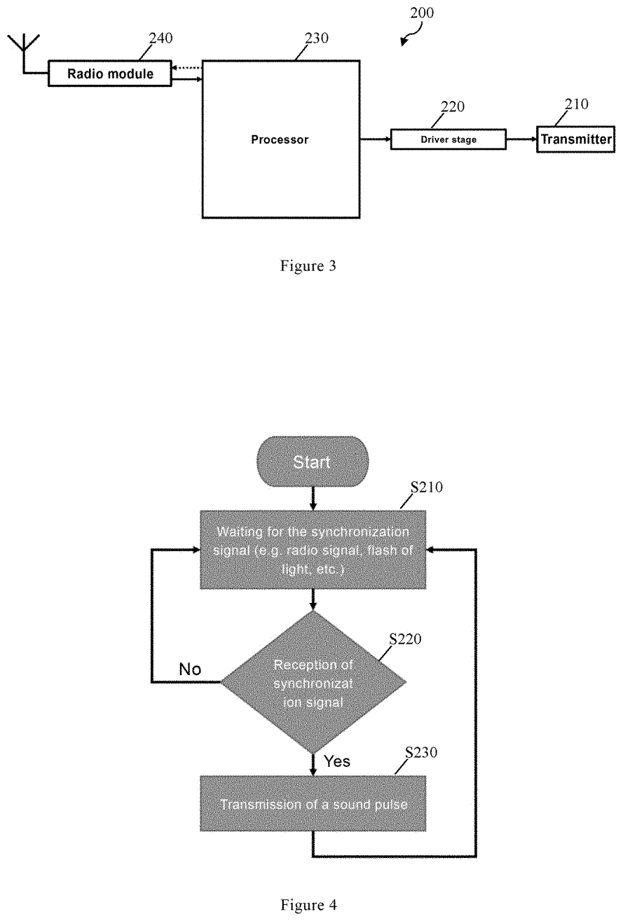

Additional functions of the processor 140 become clear from the following description of FIGS. 2 to 14.

The processor 140 is further connected to a radio module 150. The radio module 150 is, in particular, configured to transmit a synchronization signal. The transmission of the synchronization signal can be initiated by the processor 140, for example, to provide a defined start time for the time-of-flight measurements described in more detail below.

The radio module 150 can communicate with the processor 140 and report a successful transmission of the synchronization signal to the processor 140. Furthermore, the radio module 150 can receive an acknowledgement from the transmitting unit, wherein the acknowledgement confirms the receipt of the synchronization signal.

FIG. 2 shows a flowchart with steps that the receiving unit 100 performs according to an embodiment of the invention.

In step S110, a synchronization signal is transmitted by the radio module 150 of the receiving unit 100. The synchronization signal can, for example, be a radio signal, a flash of light, etc.

In step S120, three timers are started, wherein one timer is assigned to one of the receivers 110, 120, 130 in each case. Preferably, the timers are started essentially at the same time as the synchronization signal is transmitted, in order to determine the respective time-of-flight of the signal from the transmitting unit to the respective receiver 110, 120, 130.

In step S130, the signals received by the respective receivers 110, 120, 130 are searched for the ultrasonic signal from the transmitting unit. In other words, the receivers 110, 120, 130 receive incoming ultrasonic signals, which are forwarded to the processor 140 through the subsequent amplifying and filtering units 111, 121, 131. The processor 140 is configured to process the signals and to identify, among the various signals, those signals received from the transmitting unit directly at the respective receiver 110, 120, 130.

Possible interference signals can, for example, originate from reflected signals corresponding to signals reflected on surfaces from the signal transmitted by the transmitting unit.

In step S140, a respective time-of-flight of the signal from the transmitting unit to the respective receiver 110, 120, 130 is determined by the processor 140 using the aforementioned timers. The respective time-of-flight corresponds to the time that the signal, which was transmitted by the transmitting unit, needs to reach the respective receiver 110, 120, 130.

In step S150, the 3D coordinates of the transmitting unit are determined by the processor 140 based on the determined three times-of-flight. The determination of the 3D coordinates based on the determined times-of-flight is described in more detail below.

In step S160, the determined 3D coordinates are output by the processor 140 and the method can be performed again.

FIG. 3 shows a schematic representation of the transmitting unit 200 according to an embodiment of the invention. The transmitting unit 200 comprises a transmitter 210, a driver stage 220, a processor 230 and a radio module 240.

The transmitter 210 is configured to transmit an ultrasonic signal. The transmitter is connected to a driver stage 220 which drives the transmitter 210.

The processor 230 is connected to the driver stage 220. The processor 230 is connected to a radio module 240. The processor 230 essentially takes over the control of the components of the transmitting unit 200.

The radio module 240 is configured to receive a synchronization signal, e.g. a radio signal or flash of light, etc., and to report the receipt of the synchronization signal to the processor 230.

FIG. 4 shows a flowchart with steps that the transmitting unit 200 performs according to an embodiment of the invention.

In step S210, the transmitting unit 200 waits for a synchronization signal from the receiving unit 100. This could be referred to as a stand-by mode, wherein the transmitter 210 does not transmit an ultrasonic signal in this mode.

In step S220, it is determined whether a synchronization signal has been received by the radio module 240. If no synchronization signal was received at the radio module 240, the method goes back to step S210 and performs steps S210 and S220 again.

Steps S210 and S220 can, for example, be repeatedly performed at predetermined intervals.

If a synchronization signal is received at the radio module 240, the method proceeds to step S230.

An ultrasonic signal is transmitted by the transmitter 210 in step S230. After the ultrasonic signal has been transmitted, the method goes back to step S210 and the steps described above can be performed again.

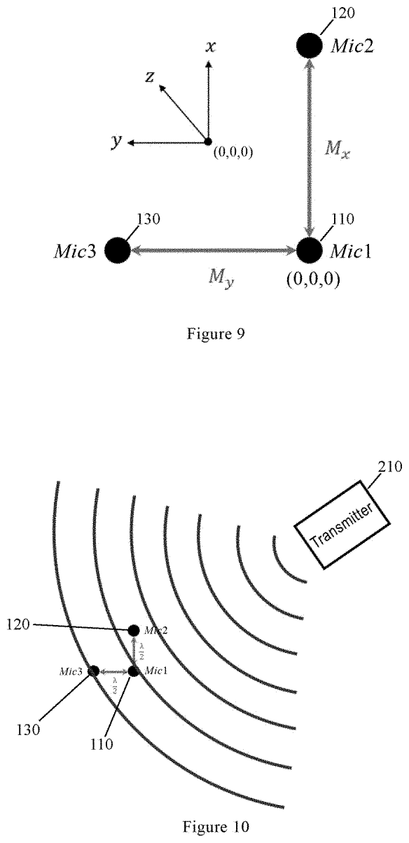

With reference to FIGS. 5 and 6, the arrangement of the receivers 110, 120, 130 of the receiving unit 100 according to an embodiment is described in more detail below.

FIG. 5 shows a schematic representation of the arrangement of the three receivers 110, 120, 130 of the receiving unit 100 according to an embodiment of the invention.

In the representation of FIG. 5, the receiver 110 is located at the point (s, k_{Mic1}, e₁) in relation to a predetermined coordinate origin (0, 0, 0) of an x, y, z coordinate system. The receiver 120 is located at point (Mₓ, k_{Mic2}, e₂). The receiver 130 is located at a distance My (k_{Mic3}, M_{y}, e₃).

The distances between the receivers 110, 120, 130 are at most equal to λ/2, wherein λ corresponds to the wavelength of the signal transmitted by the transmitting unit 200, i.e.:

$$\sqrt{{( {M}_{x} - s )}^{2} + {( {k}_{Mic 2} - {k}_{Mic 1} )}^{2} + {( {e}_{2} - {e}_{1} )}^{2}} \leq \frac{λ}{2} ,$$

$$\sqrt{{( {k}_{Mic 3} - s )}^{2} + {( {M}_{y} - {k}_{Mic 1} )}^{2} + {( {e}_{3} - {e}_{1} )}^{2}} \leq \frac{λ}{2} .$$

It will be clear to the person skilled in the art that the position of the aforementioned coordinate system can be chosen at will. For the following description it is assumed that the receivers 110, 120, 130 are located in one plane, i.e. e₁=e₂=e₃=0.

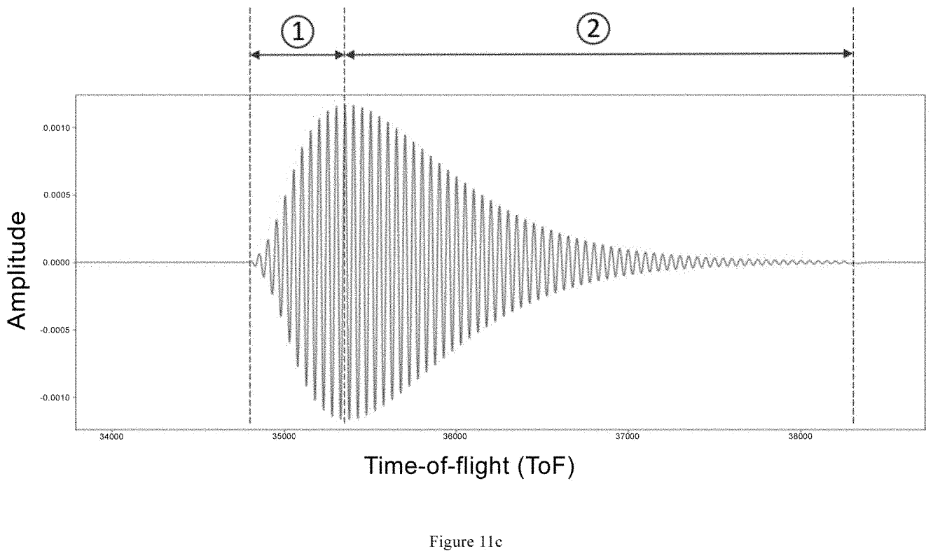

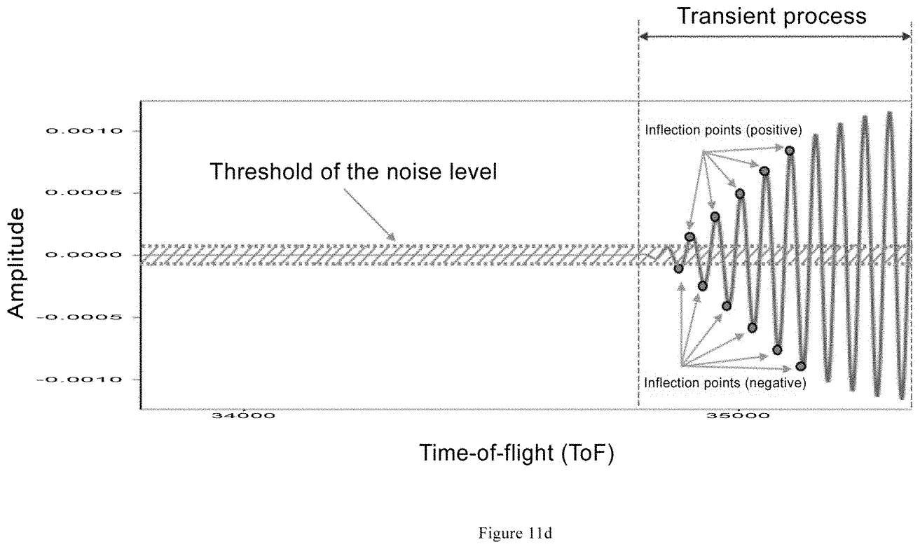

The propagation of the signal from the transmitting unit 200 is shown in FIG. 9 and a corresponding received signal from the three receivers 110, 120, 130 is shown in FIG. 10. FIGS. 9 and 10 will be described in more detail below based on a further exemplary embodiment, but apply in an equivalent manner to the exemplary embodiment described here with reference to FIGS. 5 to 8.

The calculation of the 3D coordinates of the transmitting unit 200 is described in more detail below with reference to FIGS. 6 to 8.

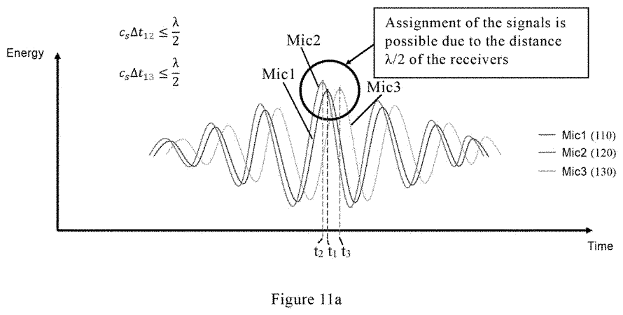

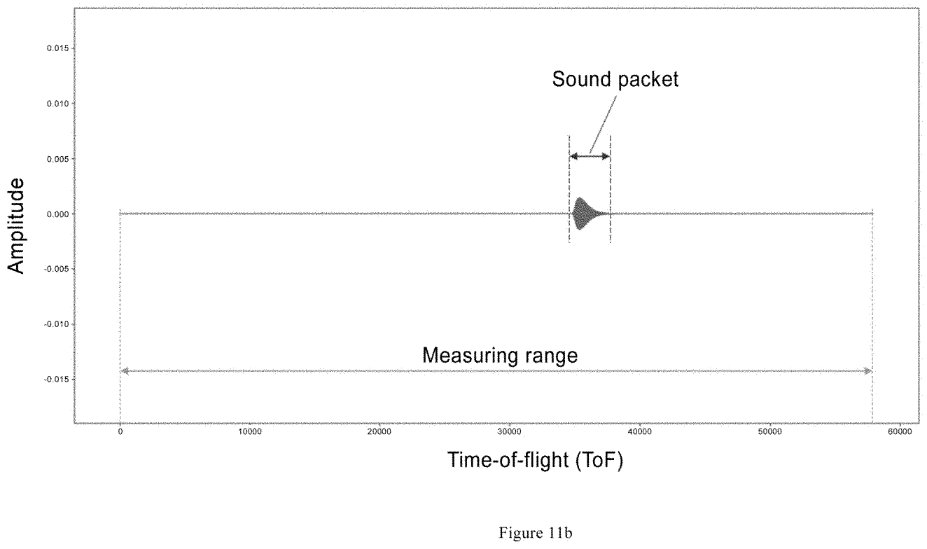

FIG. 6 shows a schematic representation for determining the x-coordinate of the transmitting unit according to an embodiment of the invention. FIG. 7 shows a schematic representation for determining the y-coordinate of the transmitting unit according to an embodiment of the invention. FIG. 8 shows a schematic representation for determining the z-coordinate of the transmitting unit according to an embodiment of the invention.

FIG. 6 shows the receiver 110 (also referred to as the first receiver 110), the receiver 120 (also referred to as the second receiver 120), and the transmitter 210. The previously determined times-of-flight U₁ and U₂ of the signal from the transmitter 210 to the respective receiver 110, 120 correspond to the radii of two circular paths U₁ and U₂ around the respective receiver 110, 120, as shown in FIG. 6.

The corresponding coordinate equations with the coordinate origin at the location of the first receiver 110 for the circular paths U₁ and U₂ shown in FIG. 6 are as follows:

U₁²=xv²+z_{2D}²,

U₂²=(xv−Mₓᵥ)²+z_{2D}².

Mₓᵥ designates the distance between the first receiver 110 and the second receiver 120. U₁ and U₂ designate the respective radius of the circular paths. xv designates the xv-coordinate of the transmitter 210 and z_{2D} designates the z-component of the transmitter 210 in an xv, z_{2D}-coordinate system, wherein the xv-axis is defined by the first receiver 110 and the second receiver 120.

The coordinate equations above can be rearranged to make z_{2D} the subject and then equated, resulting in the following equation:

U₁²−xv²=U₂²−(xv−Mₓᵥ)².

The line segment Mₓᵥ between the first receiver 110 and the second receiver 120 is calculated as follows:

Mₓᵥ=\sqrt{(Mₓ−s)²+(k_{Mic2}−k_{Mic1})²}.

The equated coordinate equations can be rearranged to make xv the subject and inserting Mₓᵥ results in:

$$x v = \frac{{U}_{1}^{2} - {U}_{2}^{2} + {( {M}_{x} - s )}^{2} + {( {k}_{Mic 2} - {k}_{Mic 1} )}^{2}}{2 \sqrt{{( {M}_{x} - s )}^{2} + {( {k}_{Mic 2} - {k}_{Mic 1} )}^{2}}} .$$

Thus, the xv-coordinate of the transmitter 210 can be determined in the xv,_{z2D}-coordinate system.

FIG. 7 shows the receiver 110 (also referred to as the first receiver 110), the receiver 120 (also referred to as the second receiver 120), the receiver 130 (also referred to as the third receiver 130), and the transmitter 210. FIG. 9 shows the determination of the x-coordinate and the y-coordinate of the transmitter 210.

First, the rotation angle α of the line segment xv to the origin coordinate system is determined as:

$$α = arctan ( \frac{{k}_{Mic 2} - {k}_{Mic 1}}{{M}_{x} - s} ) .$$

The rotation angle α can be used to determine the line segment M_{yv} and the line segment kv_{Mic3} as follows:

M_{yv}=−(k_{Mic3}−s)sin(α)+(M_{y}−k_{Mic1})cos(α),

kv_{Mic3}=(k_{Mic3}−s)cos(α)+(M_{y}−k_{Mic1})sin(α).

The coordinate equations for the spherical surfaces of the spheres with the radius of the respective times-of-flight U₁ and U₂ are as follows:

U₁²=xv²+yv²+z² and

U₃²=(xv−kv_{Mic3})²+(yv−M_{yv})²+z².

The coordinate equations can be rearranged to make z the subject and equated:

U₁²−xv²−yv²=U₃²−(xv−kv_{Mic3})²−(yv−M_{yv})².

The equated coordinate equations can be rearranged to make yv the subject as follows:

$$y v = \frac{{U}_{1}^{2} - {U}_{3}^{2} + {M}_{y v}^{2} - x {v}^{2} + {( x v - k {v}_{Mic 3} )}^{2}}{2 {M}_{y v}} .$$

The xv- and yv-coordinates can be traced back to the corresponding x- and y-coordinates using the rotation around the angle α:

x=xv cos(α)−yv sin(α)+s,

y=xv sin(α)−yv cos(α)+k_{Mic1}.

FIG. 8 shows the line segment U₁ between the receiver 110 and the transmitter 210. The line segment U₁ can be expressed as a vector \vec{U₁}:

$$\vec{{U}_{1}} = ( \begin{matrix}x \\ y \\ z\end{matrix} ) .$$

The magnitude of the vector \vec{U₁} corresponds to the time-of-flight of the signal:

\sqrt{|U₁|}=\sqrt{x²+y²+z²}.

This equation can be rearranged to make z the subject, resulting in the following equation for the z-coordinate of the transmitter 210:

z=\sqrt{U₁²−x²−y²}.

The z-coordinate of the transmitter 210 can thus be determined using the previously determined x-coordinate and y-coordinate as well as the time-of-flight U₁.

The calculations described above are preferably performed by the processor 140 of the receiving unit 100. The aforementioned calculation was described in relation to the transmitter 210. It is clear to the person skilled in the art that the aforementioned calculation relates to the transmitting unit 200, which comprises the transmitter 210.

With reference to FIGS. 9 to 11a, the arrangement of the receivers 110, 120, 130 of the receiving unit 100 and the propagation and reception of the signal of a further exemplary embodiment are described in more detail below.

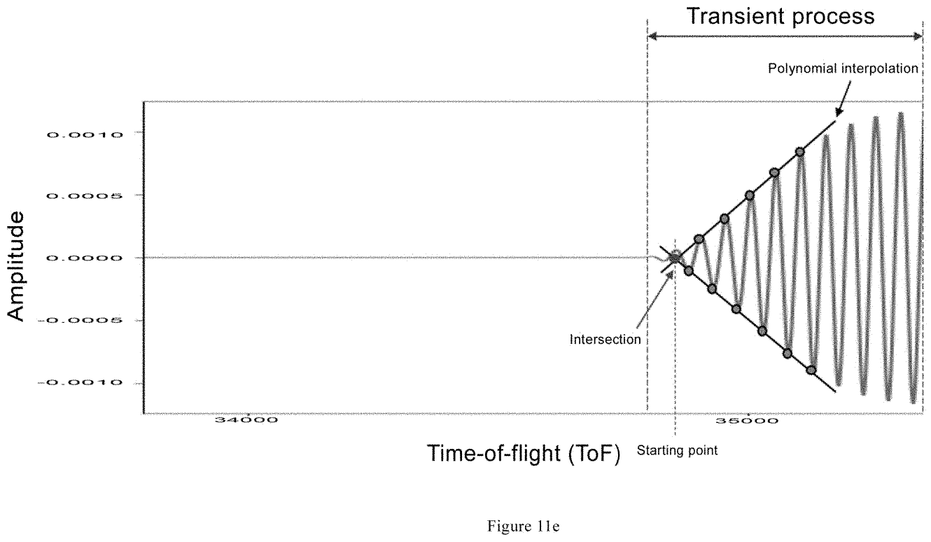

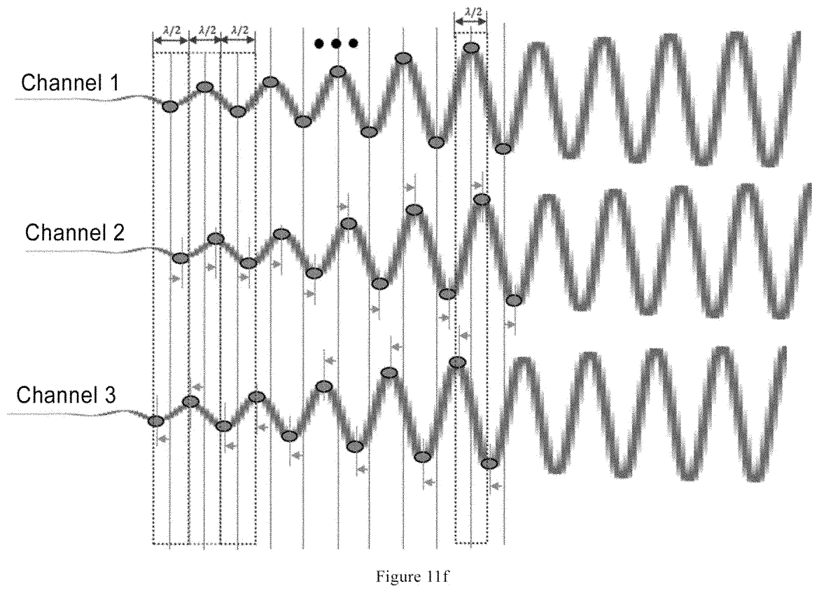

FIG. 9 shows a schematic representation of the arrangement of the three receivers 110, 120, 130 of the receiving unit 100 according to an embodiment of the invention. FIG. 10 shows a schematic representation of the propagation of the signal from the transmitting unit 200 to the receiving unit 100 according to an embodiment of the invention. FIG. 11a shows an energy-time diagram of the received signals at the three receivers 110, 120, 130 of the receiving unit 100 according to an embodiment of the invention.

In the representation of FIG. 9, the receiver 110 is located at the origin (0,0,0) of an “x, y, z”-coordinate system. The receiver 120 is located at a distance Mx (Mx,0,0) from the receiver 110. The receiver 130 is located at a distance My (0,My,0) from the receiver 110. The distances Mx and My between the receivers 110, 120, 130 are at most equal to λ/2, wherein λ corresponds to the wavelength of the signal transmitted by the transmitting unit 200. Thus, the receivers 110, 120, 130 are arranged in one plane and the distances Mx and My are at most equal to λ/2.

Furthermore, the receivers 110 and 120 are arranged on a first straight line and the receivers 110 and 130 are arranged on a second straight line, wherein the first straight line and the second straight line are at right angles to one another. This orthogonal arrangement of the receivers 110, 120, 130 enables the calculation of the three coordinates described below via the azimuth and elevation angles, which are always at right angles to one another.

It will be clear to the person skilled in the art that the position of the aforementioned coordinate system can be chosen at will and was selected here merely as an example to explain the following calculations. The propagation of the signal from the transmitting unit 200 is shown in FIG. 10. As shown in FIG. 10, the receivers 110, 120, 130 of the receiving unit 100 receive the signal transmitted by the transmitting unit 200 at different points in time due to their spatial arrangement.

A corresponding received signal from the three receivers 110, 120, 130 is shown in FIG. 11a. By arranging the receivers 110, 120, 130 at a distance of at most one half the wavelength of the transmitted signal, a clear assignment of the received signals to the respective receiver 110, 120, 130 is possible.

The time-of-flight in the receiver 110 (Mic1) is determined as follows. First, the first inflection point of the envelope is determined. Then the first local maximum of the signal is determined, which exceeds a predetermined detection threshold. This is the time-of-flight of the signal in the receiver 110.

The detection threshold value is preferably determined before the actual time-of-flight measurement as the mean value of the received ambient/system noise. The accuracy of the times-of-flight in the receivers (Mic3) 130 and 120 (Mic2) or the differences in time-of-flight to the receiver 110 is decisive for determining the coordinates. The signals in different receivers do not resonate evenly. If the times-of-flight in the receiver 120 (Mic2) and the receiver 130 (Mic3) were assigned to the first local maximum of the signal in the receiver 110, it could happen that the phases of the individual signals in the three receivers have not yet stabilized. This assignment would then supply suboptimal values, i.e. less precise values, of the times-of-flight in the receiver 130 (Mic3) and the receiver 120 (Mic2). For this reason, it is advantageous if the phase differences or differences in time-of-flight in the receiver 120 (Mic2) and in the receiver 130 (Mic3) are determined by assigning the signals in the receiver 120 and the receiver 130 to the local maximum on the right to the first local maximum in the receiver 110, if the maximum exceeds a certain offset value to the detection threshold value (determined purely heuristically).

The “actual” times-of-flight in the receiver 120 (Mic2) and in the receiver 130 (Mic3) are preferably calculated by adding their differences in time-of-flight to the actual time-of-flight in the receiver 110.

In other words, the phase differences or time-of-flight differences in the receiver 120 (Mic2) and in the receiver 130 (Mic3) are determined by assigning the signals in the receiver 120 and the receiver 130 to the local maximum on the right to the first local maximum in the receiver 110. This is because the phase of the signals may not have stabilized at the beginning when the signal in the receiver 110 has exceeded the detection threshold. After the calculation of the phase or differences in time-of-flight of the receiver 110 to the receiver 120 and of the receiver 110 to the receiver 130, these are added back to the determined time-of-flight of the signal in the receiver 110. Thus, the times-of-flight of the signals in the receivers 120 and 130 are also obtained.

In other words, by arranging the receivers 110, 120, 130 at a distance of at most one half the wavelength of the transmitted signal, an incorrect assignment of the signals can be avoided. In particular, it should be noted that the measurement of the phases or differences in time-of-flight is relative and has nothing to do with the actual envelope maxima of the individual channels. The unambiguous assignment of the signals is not always possible at a distance greater than one half wavelength, since, for example, it is possible to receive the signals from at least two different directions with exactly the same phase position. This susceptibility to errors can be avoided by arranging the receivers 110, 120, 130 at a distance of at most one half the wavelength of the transmitted signal, as described here.

The signal processing described above is explained in more detail below with reference to FIGS. 11b-g.

FIG. 11b shows a predetermined measuring range of the time-of-flight (ToF) of the first receiver 110. The sound packet (signal) which was transmitted by the transmitting unit 200 is searched for and marked in this measuring range. Methods known from the background of the art can be used for this purpose.

The time-of-flight axis in FIG. 11b is given in ADC samples. This can be converted into the time-of-flight using the known sampling rate (samples per second).

According to an embodiment, the predetermined measuring range can be predefined/specified in the method. The measuring range can also be redefined before each individual measurement. For example, it can be specified that the beacon (ultrasonic transmitter) should be tracked within a radius of 1 m to 5 m during the first measurement. For the second measurement, it can be specified, for example, that a range of 7 m to 10 m should be tracked. With this method, the sound signal is evaluated for the time that corresponds to the measuring range.

In an alternative embodiment, e.g. only one beacon (ultrasonic transmitter) can be used in the method and the measurement can be performed up to the detection of the one beacon (ultrasonic transmitter). For example, the maximum measuring range can be set from 0 to 10 m. If the beacon is detected at 4 m, the measurement is ended and evaluated, and the measuring range for this measurement is dynamically set to 4 m.

The aforementioned values in connection with the measuring range are only given as examples to explain the general method and are not intended to restrict the content of the disclosure to the extent that the invention is restricted to these exemplary values.

According to FIG. 11c, the sound packet is divided into a transient process and a decay process and marked accordingly. The transient process can be defined, for example, as the part of the sound packet in which the magnitude of the amplitude of the oscillations increases. Accordingly, the decay process can be defined as the part of the sound packet in which the magnitude of the amplitude of the oscillations decreases. Thus, the oscillation with the greatest amplitude (magnitude of the amplitude) can define the boundary between the transient process and the decay process. The starting point or end point of the respective transient or decay process can be the first or last amplitude value≠0 (or a predetermined limit value>0).

FIG. 11d shows an enlarged section of the transient process. The inflection points of the sound signal are determined in the area of the transient process that was previously marked. The determination of the inflection points of the sound signal is limited to the inflection points that are above (positive amplitude) or below (negative amplitude) a previously defined limit value (“threshold of the noise level”). The inflection points are marked with circles in FIG. 11d and identified with arrows accordingly.

According to FIG. 11e, a polynomial interpolation is performed using the inflection points on the positive side and on the negative side. The intersection of the two polynomial functions defines the starting point (beginning) of the sound signal. The time-of-flight of the signal (sound packet) from the transmitting unit 200 to the first receiver 110 can thus be precisely determined.

The determination of the phase differences or differences in time-of-flight is described in more detail below with reference to FIG. 11f. In FIG. 11f, channel 1 designates the signal at the first receiver 110, channel 2 the signal at the second receiver 120 and channel 3 the signal at the third receiver 130.

To determine the time-of-flight (ToF) of the individual channels, i.e. at the individual receivers 110, 120, 130, the phase (time difference) between the channels is determined. In this regard, channel 1 (signal at the first receiver 110) defines the starting point. The respective inflection points of channel 1 define the centre of a search window (dashed lines in FIG. 11f) which is less than or equal to one half of the wavelength. Thus, the respective time differences between channel 1 and channel 2 and between channel 1 and channel 3 can be determined.

The corresponding time differences between the channels are determined for a plurality (preferably a predetermined number) of inflection points and the mean value is formed in order to determine a mean value for the time difference between channel 1 and channel 2 and between channel 1 and channel 3. The respective mean value can then be added to the time-of-flight of channel 1 (start time of the sound packet at the first receiver 110), determined as described above, in order to calculate the times-of-flight of the signal of channel 2 (second receiver 120) and of channel 3 (third receiver 130).

The determination of the signal quality of the signal received in the respective receiver 110, 120, 130 is described in more detail below with reference to FIG. 11g.

The signal geometry is disturbed by, for example, the transmitter, interference signals, noise and the transmission medium, which can change the frequency. These disturbances can lead to errors in the calculation of the phase difference. In order to be able to evaluate the signal quality and thus be able to detect the error, the times t_{fn} and tₚₙ identified in FIG. 11g are determined and compared with a target value.

If the identified times t_{fn} and tₚₙ are within a predetermined tolerance range, the associated inflection point is used for the averaging described above, otherwise the inflection point is discarded.

In particular, the target values (t_{fn_target} and t_{pn_target}) are determined from the transmitted signal or derived from a known ideal signal (mathematical function). Thus, it is possible to perform signal coding in the form of frequency coding.

To determine the signal quality, a tolerance range is predefined, e.g. by appropriate series of measurements. If the identified times t_{fn} and tₚₙ are within the tolerance range, the associated inflection point is used for the further calculation, otherwise the inflection point is discarded.

The number of inflection points used for further calculation results in a confidence value/reliability value. Utilizing the confidence value/reliability value determined in this manner, it is possible to perform the filtering/division/weighting using the confidence value/reliability value determined after the application of the method or to discard one or more inflection points completely or also to discard the coordinates completely at the end of the determination.

After determining the confidence value/reliability value and outputting the coordinates (with or without the confidence value/reliability value) or after discarding the coordinates, the sensor system is ready to carry out a new measurement.

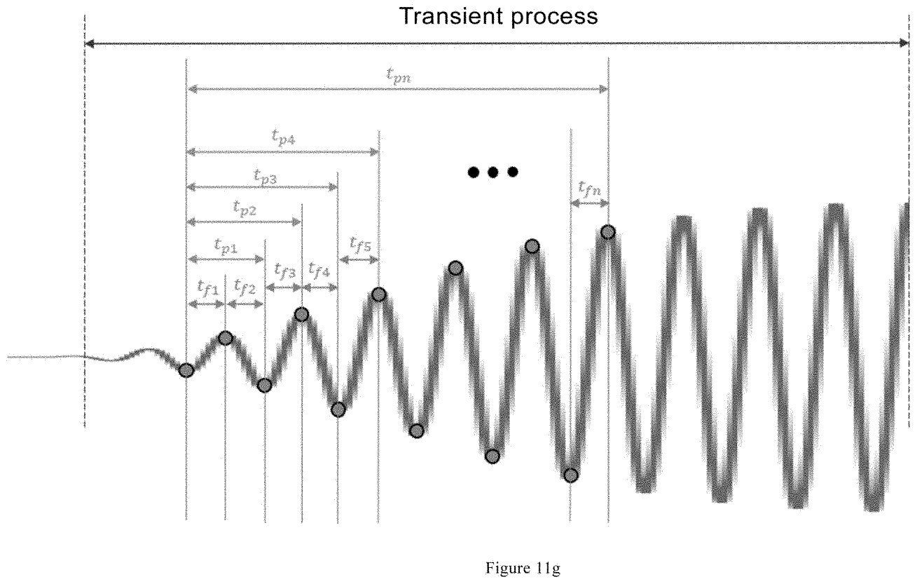

With reference to FIGS. 12 to 14, the calculation of the 3D coordinates of the transmitting unit 200 of the exemplary embodiment according to FIGS. 9 to 11 is described in more detail below.

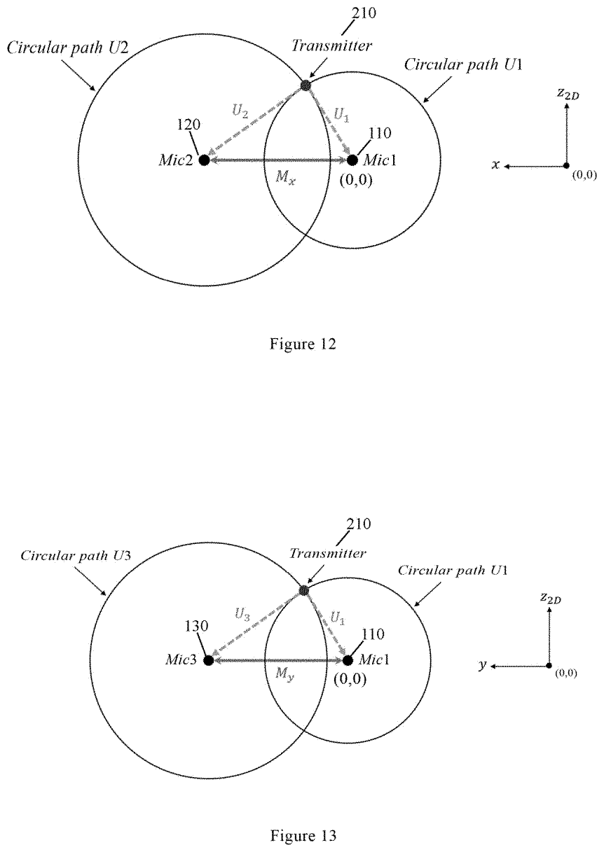

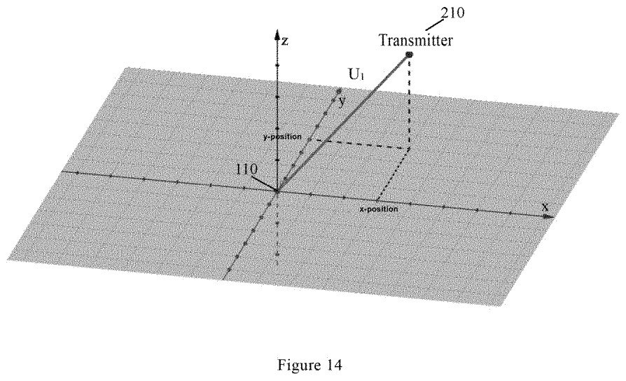

FIG. 12 shows a schematic representation for determining the x-coordinate of the transmitting unit according to an embodiment of the invention. FIG. 13 shows a schematic representation for determining the y-coordinate of the transmitting unit according to an embodiment of the invention. FIG. 14 shows a schematic representation for determining the z-coordinate of the transmitting unit according to an embodiment of the invention.

FIG. 12 shows the receiver 110 (also referred to as the first receiver 110), the receiver 120 (also referred to as the second receiver 120), and the transmitter 210. The previously determined times-of-flight U₁ and U₂ of the signal from the transmitter 210 to the respective receiver 110, 120 correspond to the radii of two circular paths U₁ and U₂ around the respective receiver 110, 120, as shown in FIG. 12.

The corresponding coordinate equations for the circular paths U₁ and U₂ shown in FIG. 12 are as follows:

U₁²=x²+z_{2D}²,

U₂²=(x−Mₓ)²+z_{2D}².

Mₓ designates the distance between the first receiver 110 and the second receiver 120. U₁ and U₂ designate the respective radius of the circular paths. x designates the x-coordinate of the transmitter 210 and z_{2D} designates the z-component of the transmitter 210.

The coordinate equations above can be rearranged to make z_{2D} the subject and then equated, resulting in the following equation:

U₁²−x²=U₂²−(x−Mₓ)².

This equation can be solved for x, which results in the following equation:

$$x = \frac{{U}_{1}^{2} - {U}_{2}^{2} + {M}_{x}^{2}}{2 {M}_{x}} .$$

The x-coordinate of the transmitter 210 can thus be determined by determining the two times-of-flight U₁ and U₂ and the distance Mₓ between the first receiver 110 and the second receiver 120.

FIG. 13 shows the receiver 110 (also referred to as the first receiver 110), the receiver 130 (also referred to as the third receiver 130), and the transmitter 210. In a manner analogous to FIG. 12, FIG. 13 shows the determination of the y-coordinate of the transmitter 210.

The previously determined times-of-flight U₁ and U₃ of the signal from the transmitter 210 to the respective receiver 110, 130 correspond to the radii of two circular paths U₁ and U₃ around the respective receiver 110, 130, as shown in FIG. 13.

The corresponding coordinate equations for the circular paths shown in FIG. 12 are as follows:

U₁²=y²+z_{2D}²,

U₃²=(y−M_{y})²+z_{2D}².

M_{y} designates the distance between the first receiver 110 and the third receiver 130. U₁ and U₃ designate the respective radius of the circular paths. y designates the y-coordinate of the transmitter 210 and z_{2D} designates the z-component of the transmitter 210.

The coordinate equations above can be rearranged to make z_{2D} the subject and then equated, resulting in the following equation:

U₁²−y²=U₃²−(y−M_{y})².

This equation can be solved for y, which results in the following equation:

$$y = \frac{{U}_{1}^{2} - {U}_{3}^{2} + {M}_{y}^{2}}{2 {M}_{y}} .$$

The y-coordinate of the transmitter 210 can thus be determined by determining the two times-of-flight U₁ and U₃ and the distance M_{y} between the first receiver 110 and the third receiver 130.

FIG. 14 shows the line segment U₁ between the receiver 110 and the transmitter 210. The line segment U₁ can be expressed as a vector \vec{U₁}:

$$\vec{{U}_{1}} = ( \begin{matrix}x \\ y \\ z\end{matrix} ) .$$

The magnitude of the vector \vec{U₁} corresponds to the time-of-flight of the signal:

\sqrt{|U₁|}=\sqrt{x²+y²+z²}.

This equation can be rearranged to make z the subject, resulting in the following equation for the z-coordinate of the transmitter 210:

z=\sqrt{U₁²−x²−y²}.

The z-coordinate of the transmitter 210 can thus be determined using the previously determined x-coordinate and y-coordinate as well as the time-of-flight U₁.

The calculations described above are preferably performed by the processor 140 of the receiving unit 100. The aforementioned calculation was described in relation to the transmitter 210. It is clear to the person skilled in the art that the aforementioned calculation relates to the transmitting unit 200, which comprises the transmitter 210.

In addition to the three-dimensional position of the transmitter, the direction of the transmitter can also be determined if needed. Determining the direction of the transmitter does not require a synchronization signal, as described above, since the difference in times-of-flight is relative and does not depend on a defined start time of the time-of-flight measurement. The differences in time-of-flight of the received signals are determined as described. The difference in times-of-flight clearly indicates the azimuth or elevation angle relative to the plane of the receiver. In this way, the direction of the transmitter can be determined.

While the present invention has been described and illustrated here with reference to preferred embodiments thereof, it will be apparent to persons skilled in the art that various modifications and changes can be made therein without departing from the scope of the invention. In this manner, it is intended that the present invention cover the modifications and changes to the present invention insofar as they fall within the scope of the appended claims and their equivalents. Furthermore, features described in connection with a particular embodiment are not to be construed exclusively in connection with other features of that embodiment. Rather, it shall be clear that a combination of features from different embodiments is also possible. Also, a feature described in connection with another feature may be present without the other feature in a possible embodiment according to the present invention.

1. A receiving unit for determining a three-dimensional position and/or direction of a transmitting unit, wherein the receiving unit comprises:
at least three receivers, each configured to receive an ultrasonic signal with a wavelength λ from the transmitting unit, wherein a first receiver is arranged at a distance of at most one half wavelength λ/2 of the ultrasonic signal from a second receiver and from a third receiver, and wherein the at least three receivers are arranged in one plane; and
a processor that is configured to determine a respective time-of-flight from the ultrasonic signal received at each of the at least three receivers, wherein the respective time-of-flight is a time that the ultrasonic signal requires from the transmitting unit at a defined start time to the respective receiver, and wherein the processor is further configured to determine the three-dimensional position and/or direction of the transmitting unit from the determined times-of-flight and the arrangement of the at least three receivers.

2. The receiving unit according to claim 1, wherein the receiving unit is further configured to transmit a synchronization signal prior to receiving the ultrasonic signal to initiate transmission of the ultrasonic signal by the transmitting unit and to define the start time, and wherein the processor is further configured to start a timer for each of the at least three receivers upon transmission of the synchronization signal to determine the respective times-of-flight.

3. The receiving unit according to claim 1, wherein the processor is further configured to determine the time of reception of the ultrasonic signal at the first receiver by intersection to determine the respective time-of-flight, wherein the intersection comprises polynomial interpolation through respective inflection points of positive and negative sides of a transient process of an amplitude of the received ultrasonic signal, wherein only the inflection points which are above a certain first limit value of the positive amplitude and wherein only the inflection points which are below a certain second limit value of the negative amplitude are used, wherein the first limit value is equal to the second limit value.

4. The receiving unit according to claim 1, wherein the processor is further configured to determine the respective time-of-flight based on a phase shift between the received ultrasonic signals and/or wherein the processor is further configured to determine the three-dimensional position of the transmitting unit based on intersecting circular paths and to determine a radius of the circular paths based on the respective time-of-flight.

5. The receiving unit according to claim 4, wherein determining the phase shift between the received ultrasonic signals comprises: determining the phase shift between respective inflection points of positive and negative sides of a transient process of an amplitude of the ultrasonic signal received at the first receiver and the ultrasonic signal received at the second receiver, and between the respective inflection points of the positive and negative sides of a transient process of the amplitude of the ultrasonic signal received at the first receiver and the ultrasonic signal received at the third receiver, and formation of a respective average value of the phase shift, and wherein the respective average values are added, in each case, to the time of reception of the ultrasonic signal at the first receiver to determine the respective time-of-flight of the ultrasonic signal to the second and third receivers.

6. The receiving unit according to claim 1, wherein the processor is further configured to determine a signal quality of the received ultrasonic signals, wherein determination of the signal quality comprises:
determining first times t_{fn} between successive inflection points of the received ultrasonic signals from a first inflection point to an n-th inflection point;
determining second times tₚₙ between the first inflection point and third through n-th inflection points; and
determining the signal quality by comparing the times t_{fn} and tₚₙ with a respective predetermined target value t_{fn_target} and t_{pn_target}.

7. The receiving unit according to claim 1, wherein the first receiver and the second receiver are arranged on a first straight line and the first receiver and the third receiver are arranged on a second straight line, wherein the first straight line and the second straight line form an angle of 80° to 100° to one another.

8. A method for determining a three-dimensional position and/or direction of a transmitting unit, comprising:
receiving an ultrasonic signal with a wavelength λ from the transmitting unit at at least three receivers of a receiving unit, wherein a first receiver is arranged at a distance of at most one half wavelength of the ultrasonic signal λ/2 from a second receiver and from a third receiver, and wherein the at least three receivers are arranged in one plane;
determining respective time-of-flight from the ultrasonic signals received at each of the at least three receivers, wherein the respective time-of-flight is a time taken for the ultrasonic signal to travel from the transmitting unit to the respective receiver at a defined start time; and
determining the three-dimensional position and/or direction of the transmitting unit from the determined times-of-flight as well as the arrangement of the at least three receivers.

9. The method according to claim 8, further comprising a step of transmitting a synchronization signal from the receiving unit prior to receiving the ultrasonic signal to initiate transmission of an ultrasonic pulse by the transmitting unit and to define the start time, and comprising a step of starting a timer for each of the at least three receivers to determine the respective times-of-flight after transmission of the synchronization signal.

10. The method according to claim 8, wherein the determination of the respective time-of-flight comprises a determination of the time of reception of the ultrasonic signal at the first receiver by intersection, wherein the intersection comprises polynomial interpolation through respective inflection points of positive and negative sides of a transient process of an amplitude of the received ultrasonic signal, wherein only the inflection points which are above a certain first limit value of the positive amplitude and wherein only the inflection points which are below a certain second limit value of the negative amplitude are used, wherein the first limit value is equal to the second limit value.

11. The method according to claim 8, wherein the determination of the three-dimensional position of the transmitting unit is performed based on a phase shift between the received ultrasonic signals and/or wherein the determination of the three-dimensional position of the transmitting unit is performed based on intersecting circular paths and a radius of the circular paths is determined based on the respective time-of-flight.

12. The method according to claim 11, wherein determining the phase shift between the received ultrasonic signals comprises: determining the phase shift between respective inflection points of positive and negative sides of a transient process of an amplitude of the ultrasonic signal received at the first receiver and the ultrasonic signal received at the second receiver, and between the respective inflection points of the positive and negative sides of a transient process of the amplitude of the ultrasonic signal received at the first receiver and the ultrasonic signal received at the third receiver, and formation of a respective average value of the phase shift, and wherein the respective average values are added, in each case, to the time of reception of the ultrasonic signal at the first receiver to determine the respective time-of-flight of the ultrasonic signal to the second and third receivers.

13. The method according to claim 8, further comprising: determining a signal quality of the received ultrasonic signals, wherein determining the signal quality comprises:
determining first times t_{fn} between successive inflection points of the received ultrasonic signals from a first inflection point to an n-th inflection point;
determining second times tₚₙ between the first inflection point and third through n-th inflection points; and
determining the signal quality by comparing the times t_{fn} and tₚₙ with a respective predetermined target value t_{fn_target} and t_{pn_target}.

14. The method according to claim 8, wherein the first receiver and the second receiver are arranged on a first straight line and the first receiver and the third receiver are arranged on a second straight line, wherein the first straight line and the second straight line form an angle of 80° to 100° to one another.

15. A non-transitory computer-readable storage medium storing a computer program comprising instructions which, when executed by a computer, cause the computer to execute the method according to claim 8.
